(19) United States
(12) Patent Application Publication
(10) Pub. No.: US 2002/0095604 A1
(43) Pub. Date: Jul. 18, 2002

(54) Encryption system and method

(76) Inventor: Jean-Philippe D. Hausler, Stillwater, OK (US)

Correspondence Address: J. Robert Brown, Esq., WORSHAM, FORSYTHE & WOOLDRIDGE, L.L.P., Energy Plaza, 30th Floor, 1601 Bryan Street, Dallas, TX, 75201-3402, US

(21) Appl. No.: 09/765,253

(22) Filed: Jan. 18, 2001

(51) Int. Cl. H04L 9/00

(52) U.S. Cl. 713/201

(57) ABSTRACT

A method for encrypting or encoding a message, or communication between the author and the intended recipient of the message or communication is provided. The method includes identifying a message or communication to be encrypted. The message or communication is provided with a plurality of characters. The method includes providing an encryption key array having a plurality of records, each record of the encryption key array includes a plurality of elements. The method further includes associating the characters of the message with the encryption key array. The position of the character within the message relative to other characters of the message is determined and associated with the position of one of the plurality of records within the encryption key array relative to the other records of the encryption key array. The character of the message is determined and associated with the position of one of the plurality of elements within the associated record of the encryption key array. Thereafter, the unique value stored at the intersection of the associated record and the associated element is determined and stored in an encrypted message.

### BACKGROUND OF THE INVENTION

1. Field of the Invention

The present invention relates generally to cryptography, and more particularly, but not by way of limitation, to an improved system and method for data encryption and decryption.

2. Description of Related Art

The great technological strides of the information era promote the transfer of vast amounts of information, digital or otherwise, over a broad range of systems, such as computer and telephone networks, satellites systems and both, standard and wireless telecommunications systems. Frequently, sensitive data is transmitted and stored in an insecure manner. As such, this sensitive data is susceptible to unauthorized access by others which compromises the confidentiality and privacy of this information.

While the degree of security desired varies greatly depending upon the environment and the sensitivity of the information, generally all communications are intended to pass directly from an author to an intended recipient without third parties eavesdropping on the contents of the message. It is frequently necessary to secure information transmitted via email or stored on computer networks from other individuals having access to the computer network, as well as those individuals obtaining network access impermissibly.

Data encryption provides the most viable solution for preventing unauthorized access to the information. Encryption is a computation or algorithm that transforms a plaintext message into unintelligible ciphertext. Decryption is typically, but not necessarily, the inverse computation or algorithm of encryption and recovers the plaintext message from the unintelligible ciphertext.

Encryption systems for encoding a message, such as computer data or communications streams, are generally based on either a secret or private key, or a combination of public and private keys. The public key systems rely on a computationally complex algorithm to achieve the encryption. These systems are undesirable since they require the user to select two very large prime numbers that are difficult to obtain and may be defeated if an efficient way to factorize the product of two large prime numbers is discovered.

Secret or private key encryption systems require the key to be kept confidential to maintain the integrity of the encrypted message. A significant limitation with respect to the privacy of messages encrypted with secret or private key encryption systems is communication of the key between the author and the intended recipient of the message. Since a secret key encryption system uses the same key to encrypt and decrypt the message, it is necessary for the recipient of the message to be in possession of the key used to encrypt the message. Keeping this key confidential is critical to the security and integrity of such encryption systems.

Secret key encryption systems are termed “symmetrical” where the same secret key is used to encode or encrypt the message, as well as to decode or decrypt the message. Secret or private key encryption systems frequently rely on complex mathematical algorithms to achieve encryption. The complexity of these algorithms reduces the speed and efficiency of the encryption particularly when dealing with large amounts of data or streaming data, such as data or voice transmitted over computer networks, the Internet, or telecommunications systems. Thus, encrypting and decrypting data or information in realtime over these communication lines requires costly hardware modifications to the communication devices. Also, secret or private key encryption systems partition the message to be encrypted into restrictive sizes such as blocks of fixed lengths which limits the possible key lengths available and severely undermines the security provided for the encrypted message.

To this end, a need exists for a secret or private key encryption system that provides the security of public key encryption systems without the associated computational complexity, thus improving the efficiency and speed of the encryption system. Furthermore, a need exists for an encryption system wherein the encryption key is not limited in length by the encryption algorithm to provide greater security. A need also exists for a safer, more secure means of communicating the secret key used by a user of a private key encryption system. In addition, a need exists for a more secure method of transmitting a secret or private key between the author and the recipient of encrypted messages.

### SUMMARY OF THE INVENTION

In one aspect, the present invention is directed to a method for encrypting or encoding a message, or communication between the author and the intended recipient of the message or communication. The method includes identifying a message or communication to be encrypted. The message or communication is provided with a plurality of characters. The method further includes providing an encryption key array. The encryption key array includes a plurality of records, each record of the encryption key array includes a plurality of elements. The encryption key array is generated such that each element of one of the plurality of records contains a value that is unique to the value contained in each other element in the same record of the encryption key array.

The method further includes associating the characters of the message with the encryption key array. The position of the character within the message relative to other characters of the message is determined and associated with the position of one of the plurality of records within the encryption key array relative to the other records of the encryption key array. The association further requires that the nature of the character of the message be determined and associated with the position of one of the plurality of elements within the associated record of the encryption key array. Thereafter, the unique value stored at the intersection of the associated record and the associated element is determined.

The method further includes generating an encrypted message by storing the unique value representing the association of the encryption key array with each character of the message. The encrypted message thereby contains the stored values which represent encrypted characters. The message is thereby rendered an incomprehensible encrypted message to eavesdroppers.

The method further provides for decrypting the message by associating the encrypted characters of the encrypted message with the encryption key array. The position of the encrypted character within the encrypted message relative to the other encrypted characters of the encrypted message is determined and associated with the position of one of the plurality of records within the encryption key array relative to the other records of the encryption key array. The encrypted character of the encrypted message is then associated with one of the unique values contained within one of the plurality of elements of the associated record. The element within which the associated unique value resides is determined and stored in a decrypted message. The decrypted message thereby contains the stored values representing the original characters of the message.

In another aspect, the present invention is directed to a method for concealing information within a data file. The method includes providing a first data file, such as, but not limited to, a computer audio file, video file, audio-visual file, graphics file, plain-text file, or binary file. The first data file includes a plurality of records. Each record of the first data file includes a plurality of elements. The method includes providing information to be concealed, such as an encryption key array having a plurality of elements. The method provides for generating a second data file by combining elements of the information to be concealed with elements of the first data file.

The combination is accomplished by associating at least one element of the information to be concealed with one of the plurality of records within the first data file and further associating the information to be concealed with one of the plurality of elements of the associated record of the first data file. Based upon this association, a value is obtained relative to the association of the information to be concealed with the data file. The value is then stored in the second data file. Once all the information to be concealed has been associated with the first data file, all remaining elements of the first data file are transferred to and stored unchanged in the second data file. The second data file generated by this method is substantially similar to the first data file in that the audio, video, audio-visual, and graphic qualities are maintained, in effect concealing the encryption key array within the second data file.

Other objects, features, and advantages of the present invention will be apparent to those skilled in the art from the following detailed description when read in conjunction with the accompanying drawings and appended claims.

### BRIEF DESCRIPTION OF THE SEVERAL VIEWS OF THE DRAWINGS

FIG. 1 is a block diagram of an encryption system in accordance with the present invention employing an encryption key array.

FIG. 2 is a diagramatic illustration of a file format employed by both a message and an encrypted message of the encryption system shown in FIG. 1.

FIG. 3 is a diagramatic illustration of the format of the encryption key array illustrated in FIG. 1.

FIG. 4 is a block diagram of a computerized system constructed in accordance with the present invention employing the encryption system.

FIG. 5 is a flow-chart showing a method of encryption in accordance with the present invention.

FIG. 6 is a flow-chart showing a method of decryption in accordance with the present invention.

FIG. 7 is a block diagram of another embodiment of an encryption system of the present invention employing a computer file as an encryption key array.

FIG. 8 is a block diagram of another embodiment of an encryption system for embedding an encryption key array as a message in a computer file.

FIG. 9 is a block diagram illustrating a communications network employing the encryption system of the present invention.

### DETAILED DESCRIPTION OF THE INVENTION

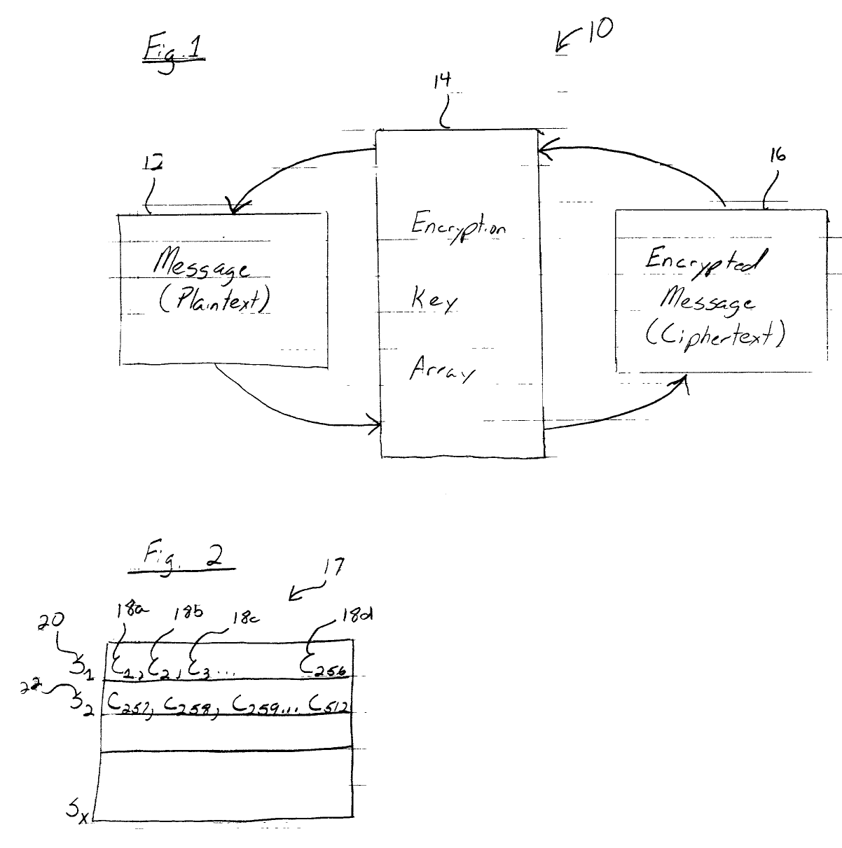

Referring now to the drawings, and more particularly to FIG. 1, an encryption system 10 constructed in accordance with the present invention is illustrated. The encryption system 10 of the present invention can be employed by individuals, businesses, and governmental entities to securely transmit a message 12 to others while maintaining the secrecy and privacy of the contents of the message.

The encryption system 10 includes a method of encrypting the message 12 to be encrypted. The message 12 may be an ordinary plaintext computer file resident on a magnetic, optical, or other storage device capable of storing computer files. It is contemplated that the encryption system 10 may be employed to secure communications transmitted over a variety of communication technologies such as, but not limited to, computer networks such as local or wide area networks or the Internet, telecommunications systems, digital, cellular or other wireless communications, whether digital, analog other standards are used for the communications, and other forms of information and transmitted communications which are well known to one of ordinary skill in the art. The message 12 will be described for simplicity as an ordinary plaintext computer file residing on a computer accessible medium generated by computer application software which is well known and commonly available.

The encryption system 10 and method of the present invention further includes an encryption key array 14 and an encrypted message 16. The encrypted message 16 is generated by associating the message 12 with the encryption key array 14 to generate a undecipherable, or ciphertext, encrypted message 16. The encrypted message 16 is then stored or transmitted in an unsecure manner since eavesdroppers, other than the intended recipient, are unable to determine the content of the original message 12 from the encrypted message 16. The intended recipient thereafter associates the encrypted message 16 with the encryption array 14 and in this manner derives the original message 12 and its private contents.

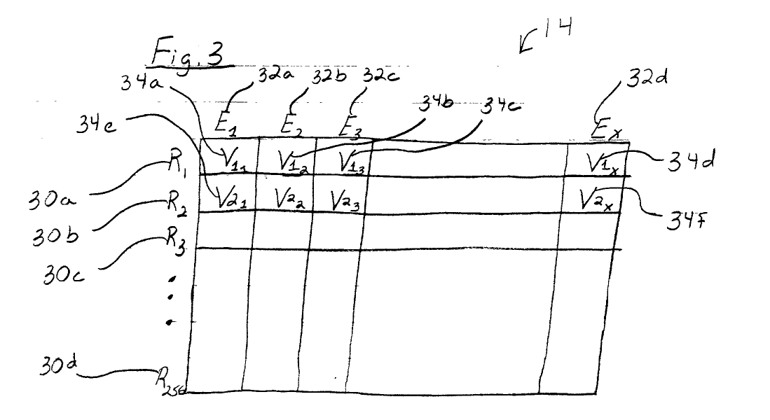

Referring now to FIG. 2, the diagramatic illustration of the file format 17 employed by the message 12 and the encrypted message 16 is shown. The file format 17 includes a plurality of characters 18, only the first four characters 18 are denoted alpha-numerically for purposes of clarity, specifically, characters 18a, 18b, 18c and 18d. The file format 17 represents an arrangement of the characters 18 in an organization ascertainable by information systems, such as a standard network or personal computer systems, or other communication and/or information systems.

The file format 17 shown in FIG. 2 represents a standard data type computer file resident on generic personal computer systems and organized in a computer industry standard file format commonly known as ASCII (American Standard Code for Information Interchange). In this manner, the characters 18 are organized in strings 20 representing groups of characters 18. Character 18a represents the first character 18 in the file format 17 and the first character 18 in the string 20, and character 18d represents the last character in the string 20, such as in a standard ASCII file. In this organization the next string 22 contains characters 18 ranging from positions 257 to 512 in the file format 17 and continuing to an upper limit dictated by the operating system capabilities of the computer system and the ASCII format.

While the file format 17 shown in FIG. 2 is similar to that of a standard ASCII file, it should be understood that the message 12 and encryption message 16 may be a file of any format such as those employed in other operating systems of larger or smaller computer-like devices, for example, UNIX, Windows CE, as well as information transmitted in over computer or wireless networks which are first converted into packetized groups for transmission purposes, such as PPP (Point-to-Point Protocol), TCP-IP (Transfer Communication Protocol-Internet Protocol), IP, IPX, or other protocol, such as used on socket or port communication connections and network implementation over the IP in the data-link layer and/or above the data-link layer or any other standard or method of transferring and communicating information between an originator of information and its intended recipient. In this manner, the encryption system 10 may be implemented as hardware or firmware at the various layers or communication points, or as software.

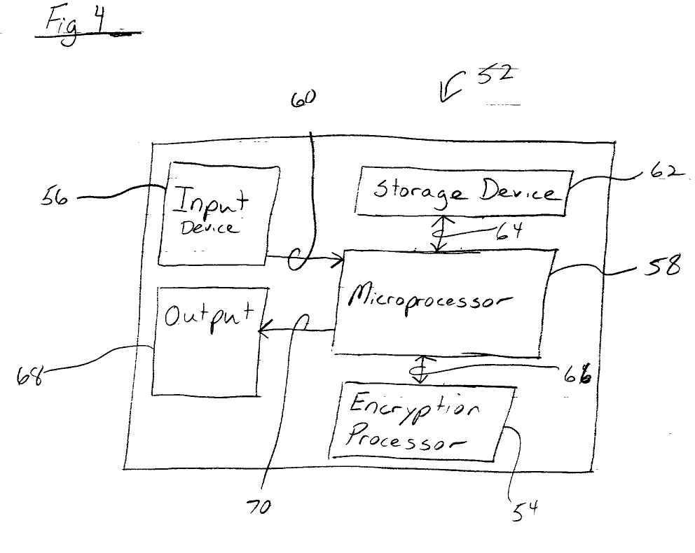

Referring now to FIG. 3, the format and organization of the encryption key array 14 is shown having a plurality of records 30 which are designated alphanumerically for purposes pf clarity 30a, 30b, 30c, and 30d. The encryption key array 14 is shown as having 256 records 30, records 30a through 30d, for purposes of uniformity with the file format 17 (see FIG. 2) of the message 12 and encrypted message 16. However, the encryption key array 14 has no limitation on the number of records 30 which may comprise the encryption key array 14 except those limitations that exist based upon the architecture of particular computer or operating systems.

Each record 30, such as the record 30a, , is provided with a plurality of elements 32 which have been denoted alphanumerically as 32a, 32b, 32c and 32d for purposes of clarity. Each element represents a columnar position within the record 30 such that element 32a would represent the first columnar position within the record 30a of the encryption key array 14. As such, element 32b represents the second columnar position, 32c represents the third columnar position and element 32d would represent the last columnar position in the record 30a of the encryption key array 14. The total number of elements 32 which may be included within any record 30 is unlimited except, as previously discussed, by the particular computer or operating system limitations.

Each element 32, such as the element 32a, contains within its columnar association with the corresponding record 30, such as 30a, a value 34, or offset, therein. This value 34 represents a character, such as any ASCII character, or in various operating system and communication environments may represent any discernable or representative numeric or alphanumeric symbol or value ascertainable by the corresponding operating system or communication environment. The plurality of values 34 are denoted alphanumerically 34a, 34b, 34c, 34d, 34e, and 34f for purposes of clarity. It can be seen that the value 34a corresponds to the columnar position of the element 32a of record 30a. Similarly, value 34b corresponds to the columnar position of element 32b of the record 30a of the encryption key array 14.

In one embodiment of the present invention, each of the values 34 contained within one of the plurality of records 30, such as the record 30a, , are unique to the other values 34 contained within the record 30a. Thus, values 34a, 34b, 34c through 34d would each be a unique character relative to the other values 34 within record 30a. Therefore, while the values 34 contained within record 30a, values 34a, 34b, 34c, and 34d may be unique to one another, these values 34 may be non-unique to the values 34 contained in the elements 32 of record 30b, such as values 34e and 34f.

In the embodiment shown in FIG. 3, the encryption key array 14 is shown as a two-dimensional array having a plurality of records 30 wherein each record 30 contains a plurality of elements 32. While there are several ways to explain such a two-dimensional array, such as a flat file of rows and columns, a two or three-dimensional array wherein the value 34 is determined by an offset, a matrix, a vector, and other methods which are well known in the art for logically organizing data in single and multi-dimensional formats, the present disclosure of the format of the encryption key array 14 shown in FIG. 3 is used for the purpose of simplicity and clarity. Therefore, it should be understood that any of the previously mentioned methods of organizing an encryption key array may be used for the present purposes and is within the spirit and scope of the embodiment disclosed herein.

The values 34 stored within the elements 32 of each of the plurality of records 30 may be randomly chosen and ordered according to any method which satisfies the aforementioned requirements that each of the values 34 within each of the records 30 is unique to the other values 34 contained within a the same record 30. The generation of these random values 34 may be accomplished by a random number generating scheme whereby a seed representing a unique input, such as a password or other character string, is used to produce randomly generated numbers. Such random generation schemes are well known in the art of mathematics, physics, computer science and engineering and for this reason no further discussion regarding random number generation is deemed necessary to teach one or ordinary skill in the art for the purpose of implementing this embodiment of the present invention.

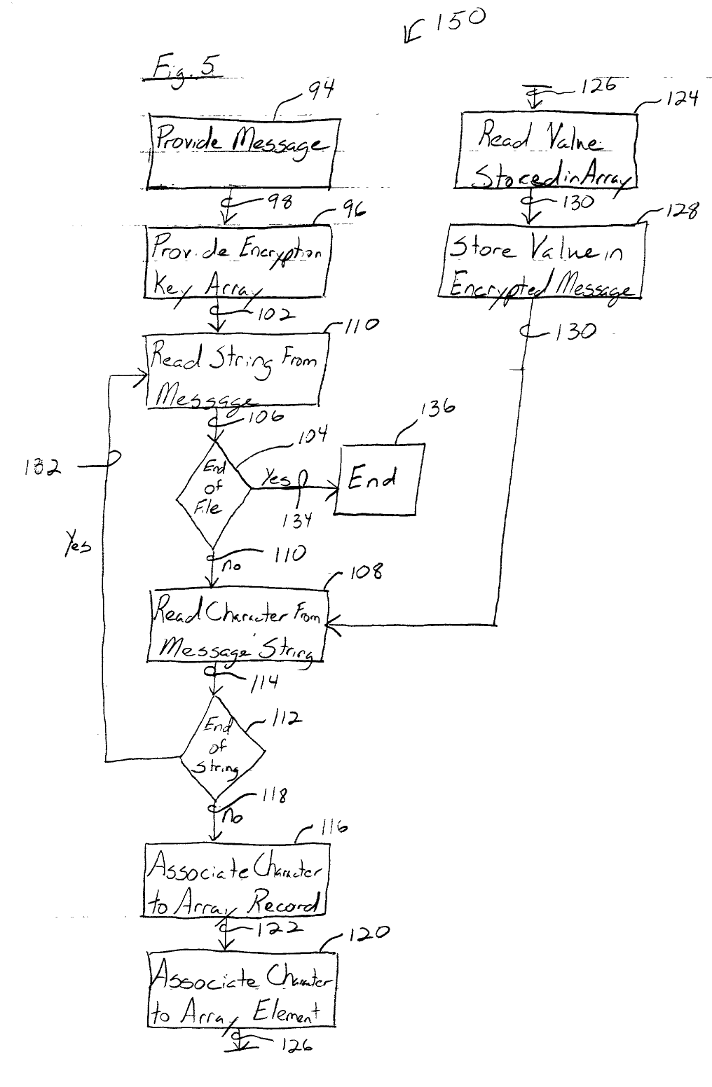

Referring now to FIGS. 4 and 5, an encryption method 50 for encrypting a message is shown. While the encryption method 50 may be implemented by a standard computer having a microprocessor, it should be understood that this process may be executed by other devices, or the steps of encryption may be embedded on microchips and microprocessors, as firmware or hardware, to increase the speed and efficiency of the encryption method 50. Embedding the present invention in a hardware device is advantageous particularly on other platforms such as digital and cellular or other wireless telephones, PDAs (Personal Digital Assistance), and other personal and portable electronic equipment now employed or later developed for speed and efficiency in encrypting streaming communications, such as voice or voice over IP, or over network systems for realtime encryption and decryption between computers on a shared network or over the Internet. As such, the encryption system 10 may be implemented as hardware or firmware for such purposes. Referring more specifically to FIG. 4, shown therein is a computer system 52 provided with an encryption processor 54 capable of carrying out the encryption method 50 in accordance with the present invention. The encryption system 52 further includes an input device 56 capable of receiving input from a user of the computer system 52, such as a computer keyboard, mouse, touch screen, voice recognition and other methods of inputting information into the computer system 52 which are well known in the art. The input device 56 is connected to a microprocessor 58 via communication line 60. The microprocessor 58 may be any microprocessor capable of executing and processing computer instructions.

The microprocessor 58 is connected to a storage device 62, via communication line 64, the storage device 62 may be any device capable of storing digital and other information, such as, but not limited to, magnetic computer hard drives, floppy drives, optical disc, tape drives and other methods now used for storing information or those employed in the future for such purposes. The microprocessor 58 is further connected to the encryption processor 54, via communication line 66, for transmitting and receiving information relative to the encryption method 50 to the encryption processor 54. The microprocessor 58 is further connected to an output device 68, via communication line 70. Although, in one embodiment, the communication lines, such as communication line 70, may provide for communication with electrical current, it will be appreciated that the communication lines may be implemented with wireless, optical or sonic methods well known in the art. The output device 68 capable of outputting information in a format perceptible to a user such as, but not limited to, printers, video monitors, speakers, and other methods employed now or in the future.

While the computer system 52 is used for the purpose of illustrating one type of system capable of carrying out the encryption method 50, it should be understood that a variety of systems may be used to carry out the encryption method disclosed herein with only minor technical adaptation, such as software loaded onto the storage device 62 where the software instructions are read and executed by the microprocessor 58. Where the encryption system 10 is implemented on a telecommunications system or computer network (not shown) between several telecommunications devices or computers, for example, the server level can provide the encryption key array 14 to a properly identified computer based upon the IP address of the computer as identified on the computer network.

Referring more specifically to FIG. 5, the encryption method 50 includes the step 94 of providing a message, such as the message 12 (see FIG. 1). The message may be generated using any input device such as the input device 56 of the computer system 52 and stored on the storage device 62. The next step 96, along a line 98, is to provide the encryption key array, such as the encryption key array 14 (see FIG. 1). The encryption key array 12 provided in this step 96 may be generated such that any necessary random generation scheme requiring a seed may be input through the input device 56 and any computational process required to generate the random numbers are accomplished through the microprocessor 58 of the computer system 52. The encryption key array 14 thereby generated may be stored by the microprocessor 58 on a storage device, such as the storage device 62 of the computer system 52.

The step 100, along a line 102, reads a string from the message 12. In the present embodiment, step 100 is accomplished by reading a string of characters equivalent to the platform standard, such as an ASCII character set of 256 characters, such as the string 20 where the message 12 has a format similar to the file format 17 (see FIG. 2). In practice, this may be accomplished by the microprocessor 58 reading portions of the message 12 retrieved from the storage device 62 (see FIG. 4) and loading this information into random access memory or other accessible memory elements which are commonly employed in modern computer and electronic devices. A step 104 along line 106 determines whether or not the end of the message 12 has been reached by the previous step 100 of reading the string 20 from the message 12. Where the end of the message 12 has not been reached, the process branches to a step 108 along line 110 where a character is read from the string 20. The character, such as the character 18a of the message 12 (see FIG. 2) is identified in this step 108.

Then, a step 112 along line 114 determines whether or not the end of the string 20 has been reached, that is whether or not there are remaining characters 18 to be read from the string 20. If the character 18a was successfully read, the process branches to a step 116 along a line 118 to associate the character to the array record. In this step 116, the position of the character 18a is associated with the encryption key array 14 by determining the position of the character 18a within the string 20 of the message 12. In one embodiment, the character 18a represents the first character 18 in the string 20 of the message 12 and is associated with the first record 30a of the encryption key array 14. Therefore, in the next iteration of the encryption method 50 the next character 18 read from message 12 would be the second character 18b in the string 20 of the message 12, and would similarly be associated with the second record 30b of the encryption key array 14. Any number of combinations of position related associations of the characters 18 in the string 20 with the elements 32 of the records 30 may be used and are within the spirit and scope of the present invention.

A step 120, via line 122, associates the character 18a to a particular element 32 of the encryption key array 14. For example, where the character 18a is an ASCII value, that ASCII value is associated with an element 32 based upon the position of the element 32 within the record 30. For example, where the character 18a had an ASCII value of zero, the character 18a would be associated with the element 32a which represents the first, or zero position, in the record 30a. If character 18a had an ASCII value of one, the character 18a would be associated with the element 32b representing the second, or position one, in the record 30a. Thus, an ASCII value of two would be associated with the element 32c representing position three in the record 30a. The association steps 116 and 120 yield a record 30 and element 32 position within the encryption key array 14.

A step 124, via line 126, reads the value 34 stored in the encryption key array 14. After the association steps 116 and 120 have been accomplished, the intersection of the associated record 30 and element 32 is determined and the value 34 stored therein is retrieved. For example, where the character 18a of the message 12 (see FIG. 2) has an ASCII value of two, it would be associated with the first record 30a of the encryption key array 14 since the character 18a is the first character 18 in the string 20 of the message 12. The ASCII value of two for the character 18a would associate with the third element 32c of the encryption key array 14. The intersection of the record 30a with the element 32c would yield the value 34c stored at this intersection. A step 128 along line 130 stores the value 34c in an encrypted message 16. In the first iteration of this step 128, a computer file is generated which contains the value 34c that was previously read in the step 124.

Therefore, the relationship of the message 12 to the encrypted message 16 is a substitution of each character 18 in the message 12 with a value 34 from the encryption key array 14. Although the characters 18 are initially read as a string 20, each character 18 is individually associated with the encryption key array 14. The random nature of the values 34 stored in the elements 32 of the encryption key array 14, when substituted through the encryption method 50, generate an encrypted message 16 of values 34 virtually undecipherable without access to the encryption key array 14. Additionally, it is readily apparent that the substitutional nature of the encryption method 50 can be employed very rapidly since there are no complex mathematical algorithms or computations necessary to generate a highly sophisticated encrypted message 16 capable of withstanding even the most aggressive and complex decryption efforts.

Then, the step 108 repeats and reads the next character 18 from the string 20 of the message 12. The process of reading the characters 18 of the message 12 continues until all of the characters 18 from the string 20 have been read, associated with values 34 in the encrypted key array 14, and thereafter stored in the encrypted message 16. When the end of the string 20 is reached, the step 112 branches along a line 132 to the step 100 where the next string 20 is read from the message 12. In an ASCII environment, the next string 20 received would represent a block of the next 256 characters. Once the end of the message 12 is reached, the step 104 branches along a line 134 to the step 136 wherein the encryption method 50 terminates. The end result of the encryption method 50 is an encrypted message 16 which is virtually undecipherable without the encryption key array 14.

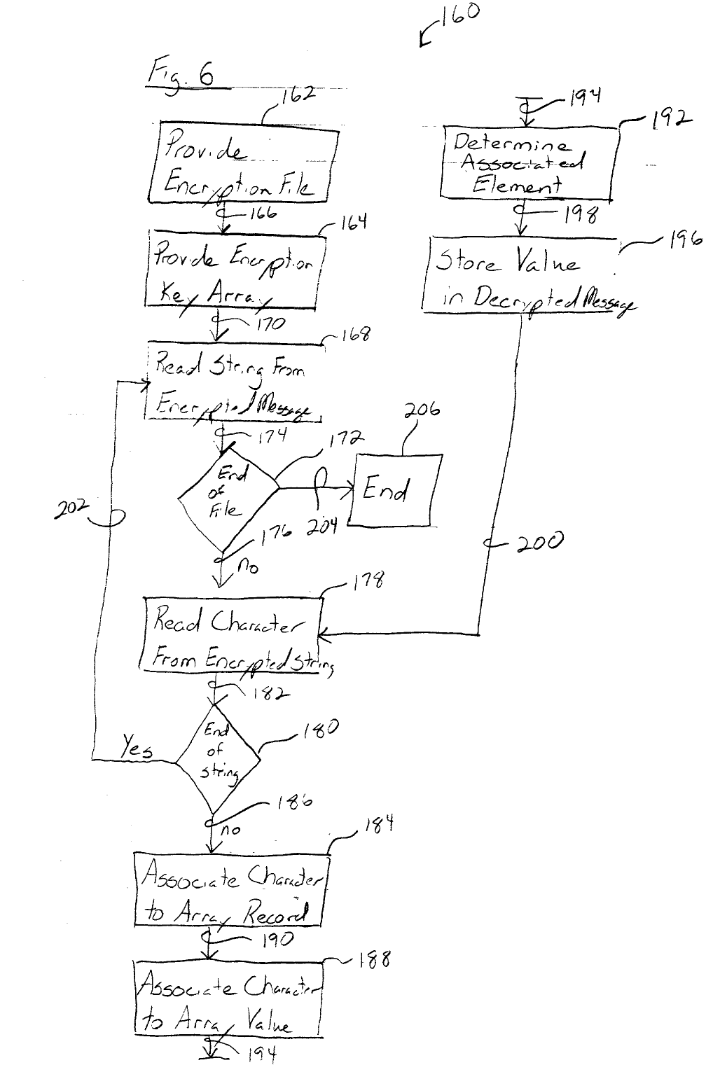

In one embodiment of the present invention, the encryption system 10 is symmetrical in that the process of decrypting the encrypted message 16 is fundamentally the inverse of the encryption method 50. Thus, the encryption key array 14 is necessary for both the encryption and decryption processes. Referring now to FIG. 6, the flow chart describes a decryption method 160 for converting the encrypted message 16 back into a readable plaintext message 12. The first step 162 ascertains the encrypted message 16 from the storage device 62 (see FIG. 4). A step 164 along a line 166 provides the encryption key array 14.

As previously mentioned, it is only possible to decrypt the encrypted message 14 with the encryption key array 14 used to originally encrypt the message 12. Methods for safely transmitting and/or communicating the encryption key array 14 to the intended recipient safely and securely will be provided hereinafter. A step 168 along a line 170 reads the string 20 from the encrypted message 16. It should be understood that the file format of the encrypted message 16 is identical to the message 12. That is, in a standard personal computer environment employing ASCII standard files, the encrypted message 16 includes a plurality of characters, such as the characters 18 of the file format 17 (see FIG. 2). Similarly, reading the encrypted message 16 is accomplished in substantially the same manner as previously discussed in view of the encryption method 50 (see FIG. 5).

A step 172, via line 174, determines whether the end of the encrypted message 16 has been reached. Where the end has not been reached, the process branches along a line 176 to a step 178 to read the characters from the string 20 of the encrypted message 16. The encrypted character 18 is read in substantially the same manner as that previously disclosed with respect to reading the message 12 in the encryption method 50 (see FIG. 5). A step 180, along a line 182, determines whether a character 18 was read or whether the end of the string 20 has been reached. Where the end of the string 20 has not been reached, the process branches to a step 184 along a line 186 to associate the character 18 read from the encrypted message 16 with a record 30 of the encryption key array 14.

Similar to the encryption method 50 (see FIG. 5), the position of the character 18, such as the character 18a, is determined based upon the position of the character 18a relative to the other characters 18 in the string 20. For example, the character 18a represents the first character 18 in the string 20 and would be associated with the first record 30a of the encryption key array 14. In this manner, additional characters 18 read in subsequent iterations, such as the character 18b which represents the second character in the string 20 (see FIG. 2) would be associated with the second record 30b or other records 30 of the encryption key array 14 based upon the position of the character 18 within the string 20. Once the character 18a has been associated with the record 30a, a step 188, via a line 190, associates the character 18a to the value 34 within the encryption key array 14. In this step 188, the character 18a is determined and associated with one of the values 34 contained within the associated record 30a in the encryption key array 14.

Since the character 18a is the first character 18 in the string 20, the character 18a would be associated with the record 30a since it is the first record 30a in the encryption key array 14. If, for example, the character 18a has an ASCII value of zero, the decryption method 160 searches the value 34 stored in each element 32 of the first record 30a until the element 32 having a stored value 34 equal to zero is found. It can be appreciated that each of the values 34 in as given record 30, must be unique to all of the other values 34 in the given record 30 for the decryption method 160 to be successful. Since each value 34 is unique within the record 30, only one element 32 of the record 30 will have the value 34 which associates or matches the character 18 of the encrypted message 16. Once the unique value 34 is ascertained from a given record 30, a step 192, via a line 194, is to determine the associated element 32. This step 192 is accomplished by determining the element 32, or position, of the value 34 within the corresponding record 30.

For example, the first character 18a in the string 20 corresponds to the first record 30a in the encryption key array 14. If, for example, the character 18a has an ASCII value of zero and the value 34a of the element 32a similarly has a value of zero, then the character 18a would match the value 34a of the encrypted key array 14. Therefore, the character 18a in this example is associated with the position corresponding to the value 34a, or element 32a. In another example, the character 18b represents the second character in the string 20 of the encrypted message 16 and has an ASCII value of zero, and the value 34e represents an ASCII zero. In this example, character 18b, being the second character in the string 20, corresponds to the second record 30b of the encryption key array 14 and the zero stored in the value 34e. Thus, character 18b associates to element 32a being the columnar position wherein the matching value 34e resides.

Once the position of element 32a has been determined, a step 196, along line 198, stores the position or element 32 into the decrypted message 12. Thereafter, the step 178, along line 200, reads the next character from the string 20. This process of reading the characters 18 from the string 20 and associating them with the record 30 and values 34 continues through the necessary iterations until the step 180 where the end of the string 20 is reached. The process branches along line 202 to the step 168 where the next string 20 is read from the message 16. When there are no more strings 20 in the encrypted message 16, and the end of the file is reached, the step 172 branches along a line 204 to a step 206 and the decryption method 160 is terminated.

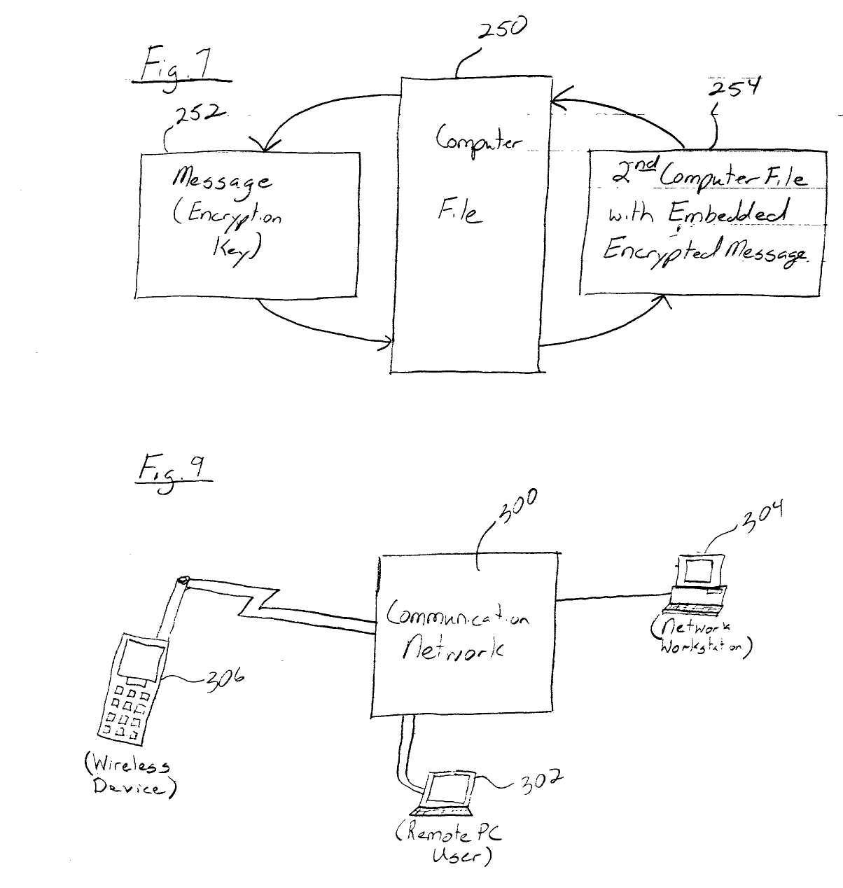

Referring now to FIG. 7, in another embodiment of the present invention a method for concealing information within a computer file 250 is provided. The computer file 250 may be any type of useful computer file wherein information is stored for useful purposes such as, audio files, video files, audio-visual files, graphics files, computer spreadsheets, word and data processing files, as well as computer databases or other arrangements of useful information. In this embodiment, a message 252 contains an encryption key array, such as the encryption key array 14 (see FIG. 3). The computer file 250 is implemented as the encryption key array, such as the encryption key array 14 (see FIG. 3). The computer file 250 necessarily has the same attributes as the encryption key array 14 in that it is provided with a plurality of records 30 and elements 32 wherein values 34 are stored. The message 252 necessarily has the same attributes as the message 12 (see. FIG. 1) in that it has a plurality of characters 18 arranged in strings 20.

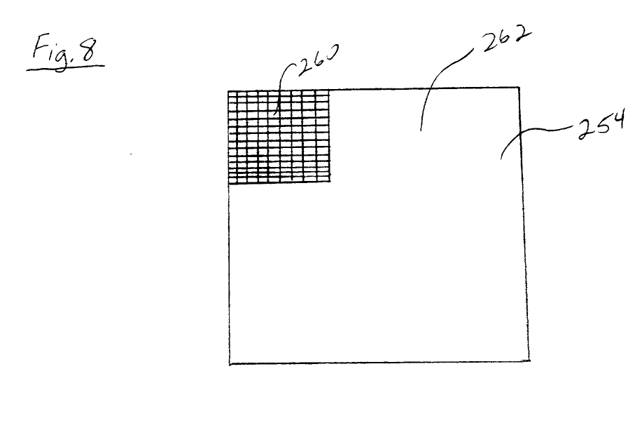

In this embodiment, the characters of the message 252 are associated with the computer file 250 to generate a second computer file 254 which is substantially similar to the computer file 250 by the encryption method 50 (see FIG. 5). Once the message 252 has been associated with the computer file 250 and resulting values 34 are stored in the second computer file 254, the remaining elements of the computer file 250 are stored in the second computer file 254 in substantially the same arrangement. Referring also to FIG. 8, the resulting second computer file 254 is shown. For example, the message 252 is an encryption key array of 256 characters along a first dimension and 256 characters along a second dimension, and the computer file 250 is a graphics file of several hundred thousand to several million bytes of information, each byte of information representing a pixel.

In this example, a first 256×256 bytes of data 260 in the second computer file 254 are derived by employing the encryption method 50 using the message 252 and computer file 250 as the encryption key. A remaining several hundred thousand to several million bytes of information 262 in the second computer file 254 would be identical in value and arrangement to that contained in the computer file 250. Therefore, by employing the encryption method 50, only a portion of the second computer file 254 is different than the computer file 250. The result is that the second computer file 254 is substantially similar to the computer file 250. When such a method is employed in a computer graphical file or sound or video file, for example, the variances in view, sound or sight between the computer file 250 and second computer file 254 are nearly undetectible.

This method of storing the encryption key within a useful computer file 250 is necessary in a secret key encryption system such as that employed in the present invention since transmitting the encryption key array 14 between the author of the message 12 and its intended recipient is necessary to both the encryption and decryption process. Embedding an encryption key array 14 within a useful computer file 250 to generate a second computer file 254 which is substantially similar, allows the author of the message 12 to transmit, for example, a pictorial image or graphics file which would not ordinarily be suspected by eavesdroppers to contain an encryption key array 14 to the intended recipient. The intended recipient can thereafter, through the decryption method 160 (see FIG. 6), remove the encryption key array 14 from the second computer file 254 and thereby be in possession of the necessary encryption key array 14 to enable the intended recipient to decrypt subsequent messages 12 received from the author of such encrypted messages 16.

Referring now to FIG. 9, in one embodiment the encryption system 10 may be implemented in on a variety of device and networks individually or integrated. For example, the encryption system 10 may be implemented on a communications network 300 directly to a remote PC user 302 or a network workstation 304 or where the communications network 300 acts a server for the remote PC user 302 and the network workstation 304. Additionally, the encryption system 10 may be implemented, for example, as firmware or hardware integrated into a wireless device 30 for communication other wireless devices (not shown) or the communications network. As such, the plain text message 12 may be resident on, for example, the network workstation 304. The encryption key array 14 may similarly be generated and be resident on the network workstation 304. The network workstation 304 then communicates the encryption key array 14 to the intended recipient, such as the wireless device 306, for example, by any method. Additionally, the network workstation 304 my desire to hide the encryption key array 14 within an ordinary computer file, such as the computer file 250 (see FIG. 7), using the method disclosed herein with reference to FIG. 7.

The network workstation 304 then encrypts the message 12 using the encryption key array 14 as described above with reference to FIGS. 2-5. The network workstation 304 then transmits the encrypted message 16 to the wireless device 306. The wireless device 306 then decrypts the message 12 using the encryption key array 16, substantially as described and shown with reference to FIG. 6.

From the above description, it is clear that the present invention is well adapted to carry out the objects and to attain the advantages mentioned herein, as well as those inherent in the invention. While the presently preferred embodiment of the invention has been described for purposes of this disclosure, it will be understood that numerous changes may be made which readily suggests themselves to those skilled in the art and which are accomplished within the spirit of the invention disclosed and as defined in the appended claims.

What is claimed is:

1. A method for encrypting a message, comprising:
identifying a message to be encrypted, the message having a plurality of characters;
providing an encryption key array having a plurality of records, each record of the encryption key array having a plurality of elements;
associating characters of the message with the encryption key array; and
generating an encrypted message by storing a value representing the association of the encryption key array with characters of the message.

2. The method of claim 1 wherein providing the encryption key includes generating the encryption key such that each element of one of the plurality of records contains a value that is unique to the value contained in each other element in the same record of the encryption key array.

3. The method of claim 2 wherein associating the characters of the message with the encryption key array includes associating the character of the message with one of the plurality of records within the encryption key array and further associating the character of the message with one of the plurality of elements of the associated record of the encryption key array and obtaining the value contained within the associated element.

4. The method of claim 3 wherein associating the character of the message with one of the plurality of records within the encryption key array comprises:
associating the position of the character within the message relative to other characters of the message with the position of one of the plurality of records within the encryption key array relative to other records of the encryption key array; and
associating the character of the message with the position of one of the plurality of elements within the associated record of the encryption key array.

5. An method for encrypting and decrypting a message, comprising:
identifying a message to be encrypted, the message having a plurality of characters;
generating an encryption key array having a plurality of records, each record of the encryption key array having a plurality of elements such that each element of one of the plurality of records contains a value that is unique to the value contained in each other element in the same record of the encryption key array;
associating characters of the message with the encryption key;
generating an encrypted message by storing encrypted characters representing the association of the encryption key array with characters of the message;
associating the encrypted characters of the encrypted message with the encryption key array; and
generating an decrypted message by storing a value representing the association of the encryption key array with encrypted characters of the encrypted message.

6. The method of claim 5 wherein associating the characters of the message with the encryption key array comprises:
associating the position of the characters within the message relative to other characters of the message with the position of one of the plurality of records within the encryption key array relative to other records of the encryption key array;
associating the characters of the message with the position of one of the plurality of elements within the associated record of the encryption key array; and
determining the value contained within the associated element.

7. The method of claim 6 wherein associating the encrypted characters of the encrypted message with the encryption key array comprises;
associating the position of the encrypted character within the encrypted message relative to the other encrypted characters of the encrypted message with the position of one of the plurality of records within the encryption key array relative to the other records of the encryption key array; and
associating the encrypted characters of the encrypted message with the position of one of the unique values contained in one of the plurality of elements within the associated record of the encrypted key array.

8. A computer-readable medium having computer-executable instructions for performing a method comprising:
identifying a message to be encrypted, the message having a plurality of characters;
providing an encryption key array having a plurality of records, each record of the encryption key array having a plurality of elements;
associating characters of the message with the encryption key array; and
generating an encrypted message by storing a value representing the association of the encryption key array with characters of the message.

9. The computer-readable medium of claim 8 wherein providing the encryption key array includes generating the encryption key array such that each element of one of the plurality of records contains a value that is unique to the value contained in each other element in the same record of the encryption key array.

10. The computer-readable medium of claim 9 wherein associating the characters of the message with the encryption key array comprises:
associating the position of the characters within the message relative to other characters of the message with the position of one of the plurality of records within the encryption key array relative to other records of the encryption key array;
associating the characters of the message with the position of one of the plurality of elements within the associated record of the encryption key array; and
determining the value contained within the associated element.

11. A system for encrypting a message, comprising:
a storage device;
a processor programmed to:
identify a message to be encrypted, the message having a plurality of characters;
provide an encryption key array having a plurality of records, each record of the encryption key array having a plurality of elements;
associate characters of the message with the encryption key array; and
generate an encrypted message by storing a value representing the association of the encryption key array with characters of the message.

12. The system of claim 11 wherein providing the encryption key array includes generating the encryption key array such that each element of one of the plurality of records contains a value that is unique to the value contained in each other element in the same record of the encryption key array.

13. The system of claim 12 wherein associating the characters of the message with the encryption key array comprises:
associating the position of the characters within the message relative to other characters of the message with the position of one of the plurality of records within the encryption key array relative to other records of the encryption key array;
associating the characters of the message with the position of one of the plurality of elements within the associated record of the encryption key array; and
determining the value contained within the associated element.

14. The method of claim 13 wherein the processor is firmware.

15. The method of claim 13 wherein the processor is hardware.

16. A method for concealing information within a data file, comprising:
providing a first data file having a plurality of records, each record of the first data file having a plurality of elements;
providing information having a plurality of elements; and
generating a second data file by combining elements of the information with elements of the first data file such that the first and second data files are substantially similar.

17. The method of claim 16 wherein generating the second data includes associating at least one element of the information with one of the plurality of records within the first data file and further associating the element of the information with one of the plurality of elements of the associated record of the first data file.

18. The method of claim 17 wherein the first data is a data file selected from a group of data files consisting of an audio file, a video file, an audio-visual file, and a graphics file, and wherein the second data file is a data file selected from a group of data files consisting of an audio file, a video file, an audio-visual file, and a graphics file.

19. The method of claim 18 wherein the information concealed within the data file is an encryption key array.

20. The method of claim 17 wherein generating the second data file further includes obtaining a value relative to the association of the information with the first data file and storing the value in the second data file.

21. The method of claim 20 wherein the first data is a data file selected from a group of data files consisting of an audio file, a video file, an audio-visual file, and a graphics file, and wherein the second data file is a data file selected from a group of data files consisting of an audio file, a video file, an audio-visual file, and a graphics file.

22. The method of claim 21 wherein the information concealed within the data file is an encryption key array.
